(19) United States
(12) Patent Application Publication
(10) Pub. No.: US 2008/0188298 A1
(43) Pub. Date: Aug. 7, 2008

(54) PROGRESSIVE GAMING DEVICE AND METHOD OF USE

(75) Inventors: Jerald C. Seelig, Absecon, NJ (US); Lawrence M. Henshaw, Hammonton, NJ (US)

Correspondence Address: IAN F. BURNS & ASSOCIATES, P.O. BOX 71115, RENO, NV, 89570, US

(73) Assignee: Atlantic City Cion & Slot Service Company, Inc., Pleasantville, NJ (US)

(21) Appl. No.: 12/026,502

(22) Filed: Feb. 5, 2008

Related U.S. Application Data
(60) Provisional application No. 60/888,292, filed on Feb. 5, 2007.

(51) Int. Cl. A63F 13/00

(52) U.S. Cl. 463/27

(57) ABSTRACT

A gaming apparatus has a gaming device that is adapted to accept a wager and allow a player to play a game. A controller is in communication with the gaming device. The controller maintains a first progressive jackpot having a first award value and a second progressive jackpot having a second award value. Upon the occurrence of a triggering event, the first and second award values are switched. A gaming method using the gaming apparatus is also disclosed.

### CROSS REFERENCE TO RELATED AND CO-PENDING APPLICATIONS

This patent application claims priority to U.S. Provisional Patent Application Ser. No. 60/888,292, filed on Feb. 5, 2007. The entire contents of which are herein incorporated by reference.

### FIELD OF THE INVENTION

The present invention relates to gaming devices and, more particularly, to a gaming device that provides several progressive jackpots that can change or switch progressive award values.

### BACKGROUND

Gaming devices are well known in the art and a large variety of gaining devices have been developed. In general, gaming devices allow users or players to play a game. In many casino-type gaming devices, the outcome of the game depends, at least in part, on a randomly generated event. For example, a gaming device may use a random number generator to generate a random or pseudo-random number (hereinafter, both types are referred to as a “random number”).

The random number can be used to determine a game outcome. For example, the random number may then be compared to a predefined table to determine a corresponding outcome of the event. If the random number falls within a certain range of numbers on the table, the player may win the corresponding predefined prize. The table may also contain display information that allows the gaming device to generate a display that corresponds to the outcome of the game. The gaming device may present the outcome of the game on a large variety of display devices, such as mechanical spinning reels or video screens.

Some gaming devices award bonus prizes in addition to prizes that are awarded in a primary game. Of course, the prize in the primary game may simply be the opportunity to play the bonus game. A bonus prize is generally defined as a prize in addition to the prize obtained from the primary game and that is awarded to the player when a predefined event occurs. An example of a bonus game can be found in U.S. Pat. No. 5,848,932 to Adams. Adams discloses a primary game having three spinning game reels and a bonus game having a bonus display with one spinning wheel. The spinning wheel is divided into multiple sections, and each section has a symbol representing a prize. When predetermined indicia are displayed on the spinning game reels of the primary game, the wheel of the bonus display spins and stops. The bonus prize is displayed as the symbol on the wheel being pointed to by a pointer. The bonus prize is awarded in addition to any prizes awarded in the primary game. Another bonus game is disclosed in Baerlocher et al. (U.S. Pat. No. 6,336,863). Baerlocher et al. discloses a slot machine with a bonus award display. The bonus award display has a bonus wheel and a mechanical, movable pointer.

Gaming devices in casinos are more successful when they are able to captivate and hold a game player's interest for a long period of time. When a game player plays a gaming device for a longer period of time, more revenue is generated for the casino. A game player may lose interest with a game that has a static display that changes very little over time or that the player deems to be unattractive.

One way gaming device manufacturers have added additional enjoyment and excitement to gaming devices is through the advent of progressive gaming. Progressive games have become very popular in casinos. Progressive slot machines contain jackpots that increase every time a player places a wager in a primary game of the slot machine. Progressive jackpots involve one or more gaming machines. For example, an individual progressive slot machine has a self-contained jackpot, wherein the jackpot grows with every play of that machine. A linked progressive includes two or more slot machines at the same or different locations connected to a common jackpot, each of which individually contribute to the jackpot. The gaming machines usually take a percentage of the player's wager, such as 2%, and add it to the progressive jackpot. This allows the progressive jackpot to grow over time. The progressive jackpots can reach sizeable amounts, such as multi-million dollar jackpots, before a player “hits” or wins the progressive jackpot.

Large progressive jackpots can be very attractive to casino game players. Furthermore, as the progressive jackpot grows, so does the game's payout percentage because the game pays out more while the likelihood of receiving the progressive award or jackpot remains constant. Players looking to inject skill or strategy into a gaming event therefore look to find progressive games having relatively high progressive jackpots, by looking for games that have not recently paid out. In an effort to further increase the excitement and enjoyment of progressive names and gaming devices in general, it is therefore desirable to inject player interaction, skill, strategy or risk into a progressive gaming device.

Progressive jackpots pay awards very infrequently. The long periods of time between progressive awards causes progressive gaming displays to appear to be very static or slowly changing. Gaming machine players may eventually lose interest in the game and stop playing. This is especially true in casino locations where a large number of linked progressives are located. It can appear to a game player in these locations that there are no winning game players and that the progressive prize will almost never be awarded. A progressive gaming device that has a display that frequently changes parameters of the progressive jackpot game can increase and prolong player interest.

### SUMMARY OF ONE EMBODIMENT OF THE INVENTION

### Advantages of One or More Embodiments of the Present Invention

The various embodiments of the present invention may, but do not necessarily, achieve one or more of the following advantages:

the ability to provide game players with a more exciting and desirable gaming experience;

the ability to attract more patrons to play a game;

provide longer play times and a greater payout possibility for a player;

provide greater revenues for gaming operators;

provide a gaming device that can randomly switch award values between two or more progressive jackpots;

provide a gaming device that utilizes a visually appealing and highly visible display;

provide a gaming device that may allow a player to see the values of two or more progressive jackpots;

provide a gaming device that may allow a player to win more than one progressive jackpot;

provide a gaming device that may allow a player to see when award values of several progressive jackpots may switch with each other; and

provide a gaming device that can use a timer to display when a jackpot will change value.

These and other advantages may be realized by reference to the remaining portions of the specification, claims, and abstract.

### BRIEF DESCRIPTION OF ONE EMBODIMENT OF THE PRESENT INVENTION

In certain embodiments, the present invention relates to a gaming apparatus that includes at least one gaming device that is adapted to accept a wager and allow a player to play a game. A controller is in communication with the gaming device. The controller maintains a first progressive jackpot having a first award value and a second progressive jackpot having a second award value. Upon the occurrence of a triggering event, the first and second award values are switched.

In other embodiments, the present invention relates to a gaining method. According to the method, a player is allowed to place a wager and play a game. A first progressive jackpot that has a first value and a second progressive jackpot that has a second value are funded. The occurrence of a jackpot switching event is detected. The first value of the first progressive jackpot is replaced with the second value of the second progressive jackpot and the second value of the second progressive jackpot is replaced with the first value of the first progressive jackpot.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one embodiment of the invention in detail, it is to be understood that the invention is not limited in its application to the details of the construction and to the arrangement of the components set forth in the following description or as illustrated in the drawings. The invention is capable of other embodiments and of being practiced and carried Out in various ways. Also, it is to be understood that the phraseology and terminology employed herein are for the purpose of description and should not be regarded as limiting.

### BRIEF DESCRIPTION OF THE DRAWINGS

FIG. 1 is substantially a front view of a gaming device of the present invention.

FIG. 2 is substantially a schematic diagram of a portion of the gaming device of FIG. 1.

FIG. 3 is substantially a schematic diagram of several of the gaming devices of FIG. 1 connected in a network.

FIG. 4 is substantially a front view of FIG. 1 showing one possible game display.

FIG. 5 is substantially a front view of FIG. 1 showing another possible game display.

FIG. 6 is substantially a front view of FIG. 1 showing yet another possible game display.

FIG. 7 is substantially a front view of FIG. 1 showing an additional game display.

FIG. 8 is substantially a flowchart of a gaming method of the present invention.

FIG. 9 is substantially a flowchart of another gaming method of the present invention.

### DESCRIPTION OF CERTAIN EMBODIMENTS OF THE PRESENT INVENTION

In the following detailed description of the embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

Game Apparatus

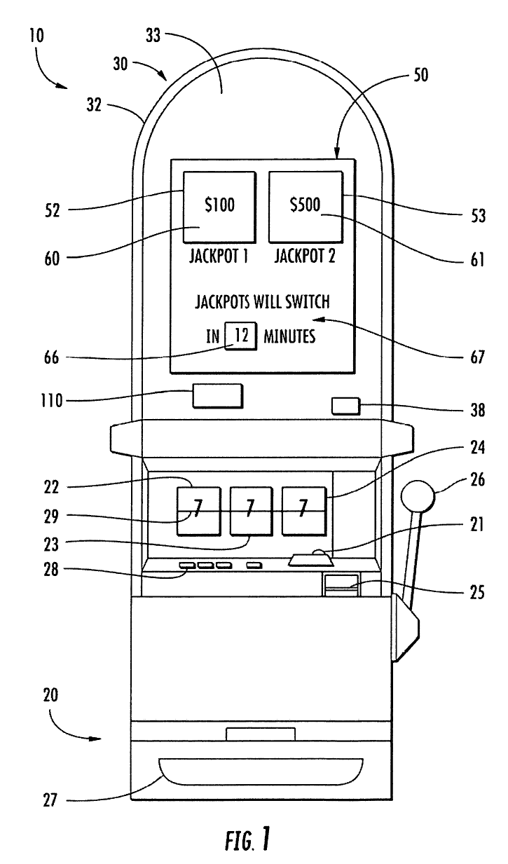

Referring to FIG. 1, one embodiment disclosed herein comprises a gaming apparatus or device, generally indicated by reference number 10. Gaming apparatus 10 comprises a primary gaming device 20 and a bonus or progressive jackpot gaming apparatus or device 30. Progressive jackpot gaming device 30 may comprise a display device 50. Gaming device 20 may be any of a large number of devices that are adapted to allow players to play a game. For example, gaming device 20 may utilize reel displays, such as spinning reels 22-24 and payline 29 or a video display (not shown), to display outcomes of the game. Means may also be provided for accepting wagers, such as a coin slot 21 or card reader 25, and for awarding prizes, such as a coin dispenser 27. A handle 26 and button 28 are provided for activating gaming device 20 to begin a game. In at least one embodiment, gaming device 20 may be an S Plus model gaming device manufactured by International Game Technology in Reno, Nev.

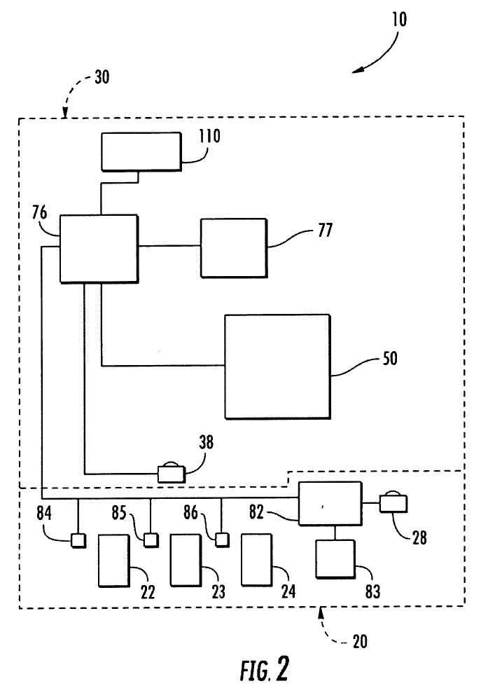

Gaming device 20 may be controlled by an electronic controller 82 (see FIG. 2) that utilizes a random number generator 83 (FIG. 2). The random number generator 83 produces a random or pseudo random number for each game. The outcome of the game may be determined by comparing the random number to a table of outcomes stored in a memory and accessed by controller 82. A number of different tables of outcomes may be used and different tables may be used for different games. The tables can be designed so that different prizes have different probabilities of being awarded. Such design techniques are well known in gaming. Examples of such designs are shown in U.S. Pat. No. 4,448,419, issued to Telnaes, and U.S. Pat. No. 5,456,465, issued to Durham. Controller 82 causes spinning reels 22-24 of the video display to show the outcome of the game that corresponds to the outcome of the random number generator 83. It is recognized that gaming device 20 may operate in many other ways and still achieve the objects of the present invention.

Gaming device 20 may also be capable of producing a jackpot qualifying or awarding event. This event may be many different types of events. For example, a jackpot qualifying or awarding event may comprise displaying a particular symbol, such as a “bonus” symbol, or combination of symbols, such as three “7” symbols, on reels 22-24 as shown in FIG. 1. If the game being played is poker based, the jackpot qualifying event may be occurrence of a certain hand, such as a royal flush. Furthermore, a jackpot qualifying event may occur when a player accumulates a number of symbols or game outcomes over a number of separate game plays. For example, a jackpot qualifying event may occur when the player receives three “jackpot” symbols during a period of time. The jackpot qualifying event may be based on an external event. For example, a jackpot qualifying event may occur when a group of players obtain a certain result.

Progressive Jackpot Game

Referring to FIGS. 1 and 2, progressive jackpot game apparatus, progressive jackpot display device or progressive jackpot gaming device 30 may have a housing 32 with a front panel 33. Housing 32 can be made from many different materials such as metal or plastic and can include decorative coverings or attachments and lights. A player input device 38 can be mounted in housing 32. Player input device 38 can be buttons or handles or rotary knobs. Player input device 38 can allow a game player to provide input to progressive jackpot gaming device 30. A display 110 such as a credit meter can be used to display prizes won oil progressive jackpot gaming device 30.

A display 50 such as a video display can be mounted in front panel 33. Display 50 can be any suitable display including video displays, plasma displays, LCD displays, LED meters and the like. Display 50 may be a single display or can be more than one display.

As seen in FIG. 1, display 50 is shown displaying two progressive jackpots. Progressive Jackpots 52 and 53 are shown in separate areas of display 50. Alternatively, progressive jackpots 52 and 53 could be shown on separate LED meters. Progressive jackpot 52 is labeled, “Jackpot 1” and progressive jackpot 53 is labeled, “Jackpot 2”.

Progressive jackpots 52 and 53 each have an associated indicia or progressive jackpot award values 60 and 61 that can be awarded to a player as a prize. Progressive jackpot award values 60 and 61 can be a wide variety of awards, such as trips, vouchers, gaming credits, comps for meals or hotels or monetary awards. A game player playing gaming apparatus 10 may be awarded one or both of progressive jackpots 52 and 53. In an embodiment, one or more of award values 60 or 61 may be a hidden or mystery progressive jackpots wherein the award value of the progressive jackpot is not revealed to the game player until after the progressive jackpot has been won.

Progressive jackpots 52 and 53 can be funded in a conventional manner wherein a percentage or portion of the wagers placed on each gaming device 10 is reserved to increase the amount of the progressive jackpots. A portion of each wager is deducted from the wager and added to the progressive jackpots thereby increasing the amount of the progressive jackpots over time until one or more of the progressive jackpots are awarded.

While a single gaming apparatus 10 with progressive jackpots 52 and 53 are shown in FIG. 1, it is understood that the progressive jackpots 52 and 53 will also be present in additional linked gaming apparatuses 10 as will be described later. When a large number of gaming apparatuses are linked together, very large progressive jackpots may result.

In one embodiment, a game player may only be allowed to play for one of the progressive jackpots. For example, the game player may only be allowed to win progressive jackpot 52. In another embodiment, progressive jackpots 52 and 53 may be multi-level progressive jackpot that can only be won or awarded in sequence. For example, a player would have to win progressive jackpots 52 first before becoming eligible to play for and win progressive jackpot 53.

Display 50 also has a timer or timer display 66 and information set 67. Information set 67 may inform a player about an operating parameter or condition of progressive jackpot gaming device 30. Information set 67 reads, “Jackpots Will Switch in ______ Minutes”. Timer display 66 can time and display the number of minutes remaining until progressive jackpots 52 and 53 switch their respective progressive jackpot award values 60 and 61. For example, in FIG. 1, timer display 66 is showing that 12 minutes remain until the progressive jackpots switch. Timer display 66 can communicate to players when the progressive jackpots will switch and build player anticipation and excitement.

Progressive jackpots 52 and 53 may switch their respective progressive jackpot award values 60 and 61 upon the occurrence of a jackpot switching event as determined by controller 76 (FIG. 2). Timer or timer display 66 may be a separate unit that may be in communication with controller 76 (FIG. 2). Alternatively, controller 76 may direct video display 50 to show timer 66.

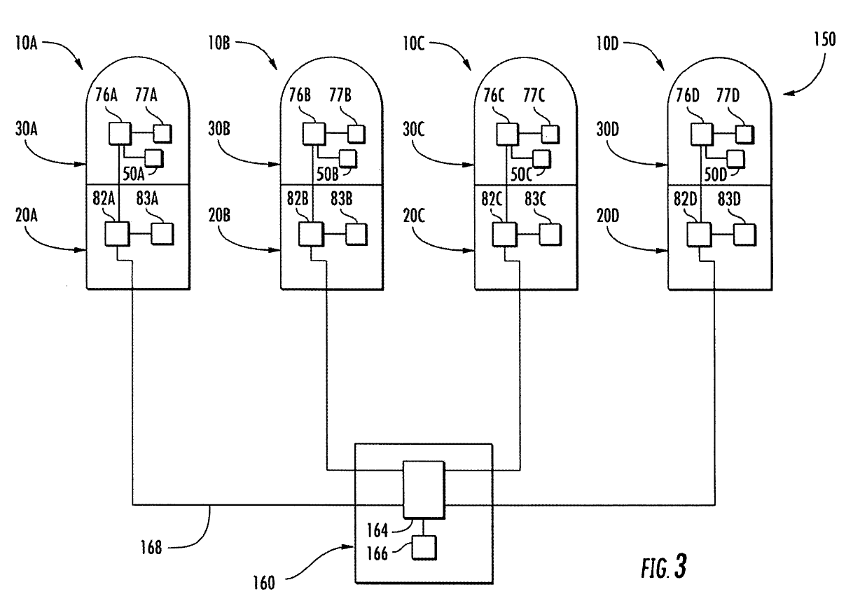

With reference to FIG. 3, a network 150 of gaming apparatuses 10 is shown. Network 150 can include several interconnected gaming apparatuses 10A, 10B, 10C and 10D. While four gaming apparatuses are shown, more or less can be used. Gaming apparatuses 10A-D can each have a primary gaming device 20A-D and a progressive jackpot gaming device 30A-D, respectively. Each of primary gaming devices 20A-D can have a controller 82A-D and random number generator 83A-D, respectively.

Gaming devices 10A-D may be in communication with a computer network server 160 through cables 168 such as an Ethernet cable. Server 160 can be a conventional network server that contains a memory 166, a controller or processor 164 and software that can operate on the processor.

Server 160 can collect and transmit game information and instructions between server 160 and gaming devices 10A-D. For example, server 160 can deduct or apportion a percentage of each wager placed on gaming devices 10A-D to fund progressive jackpots 52 and 53.

Turning now to FIGS. 1, 2 and 3, progressive jackpot gaming device 30 comprises a controller 76 that is adapted to control the operation of the progressive jackpot gaming device. Controller 76 may be one or more micro-computers or processor boards. Random number generator 77 may be in communication with controller 76. Random number generator 77 is capable of randomly generating a random number and providing the random number to controller 76. As shown in FIG. 3, each of progressive jackpot gaming devices 30A-D contains controllers 76A-D and random number generators 77A-D, respectively. Controllers 76A-D are further in communication with and can control displays 50A-D.

It is recognized that controller 76 and random number generator 77 may be a single processor or processor board. Furthermore, it is also recognized that controllers 76 and 82, and random number generators 77 and 83 may be combined in a single processor or processor board. Each of controllers 76A-D may be in communication with server 160 (FIG. 3).

Server 160 and controllers 76A-D can maintain and determine the size of progressive jackpots 52 and 53 (FIG. 1), maintain and determine the amount and method of funding of progressive jackpots 52 and 53 and maintain and determine when the award values 60 and 61 of progressive jackpots 52 and 53 will change or switch award values. Server 160 and controllers 76A-D can further cause each of displays 50 in gaining devices 10A-D to display progressive jackpots 52-55 and their current award values 60-61.

In an alternative embodiment, server 160 can control the entire operation of progressive gaming devices 30A-D and controllers 76A-D can be omitted.

Controller 76 is also adapted to detect when a progressive jackpot triggering or switching event occurs. In an embodiment, controller 76 operates a countdown timer that counts down a pre-determined or a random time period until the award values 60 and 61 of progressive jackpots 52 and 53 switch places. Controller 76 may cause the countdown timer 66 to be shown on video display 50. As shown in FIG. 1, countdown timer 66 is showing that 12 minutes remain until the progressive jackpots switch award values.

In another embodiment, controller 82 may determine the outcome of each primary game and when a jackpot triggering or switching event outcome occurs, it transmits a signal to controller 76. For example, when reels 22-24 are in a jackpot switching event position, controller 76 may switch the progressive jackpot award values. The jackpot switching event position may be a certain combination of symbols on reels 22-24 or may be a special symbol on one of reels 22-24. Controllers 76A-D or 82A-D can each inform server 160 that a jackpot switching event has occurred in one or more of gaming devices 10A-D.

In one embodiment, server 160 may determine when a jackpot triggering or switching event occurs and transmit a signal to one of controllers 76A-D. For example, server 160 may operate a countdown timer.

When controller 76 detects a progressive jackpot triggering or switching event, it may begin a progressive jackpot switching sequence. The progressive jackpot switching sequence may include activation of various lights (not shown) and sounds to attract attention to gaming apparatus 10.

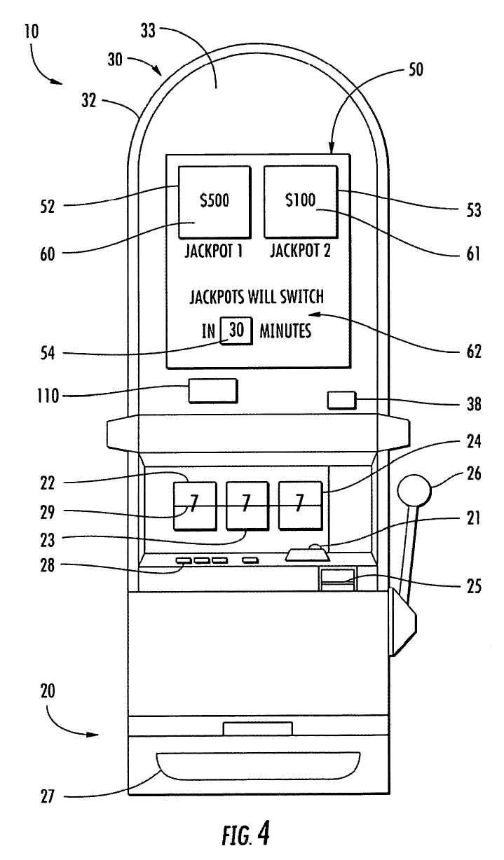

Turning now to FIG. 4, controller 76 (FIG. 2) can change or switch the progressive jackpot award values 60 and 61. The progressive jackpot award value 60 having the value of “$100” of progressive jackpot 1 (52) has been switched with the progressive jackpot award value 61 having the value of “$100” of progressive jackpot 2 (53). FIG. 4 now shows that progressive jackpot 1 (52) has a value of “$500” and progressive jackpot 2 (53) has a value of “$100”. A game player playing gaining device 10 for progressive jackpot 1 (52) now is playing for a prize or award of $500 instead of $100 which is exciting to the player.

The controller has also reset countdown timer 66. Countdown timer 66 shows that the next switching of the progressive jackpots will occur in 30 minutes. The time period shown by countdown timer 66 may be pre-determined and fixed such as every 30 minutes or may be randomly selected by controller 76 and displayed on countdown timer 66.

In a multi-level progressive embodiment, after the jackpots have been switched, the game player is now playing for a progressive jackpot 1 (52) that has a larger award value 60 of $500. A game player realizing that they now have an opportunity to win a larger progressive jackpot will be encouraged to play gaming apparatus 10 for longer periods of time in an attempt to win the larger progressive jackpot.

In progressive gaming systems of the prior art, jackpots that have higher contribution rates and larger award values have the lowest odds or probability of being awarded. Progressive jackpots with smaller award values typically have higher odds or probabilities of being awarded. In the present invention, even though the award values of the jackpots have been switched, the probability of winning the jackpots may remain the same. For example, progressive jackpot 52 may have a probability of won once for every 10,000 wagers and progressive jackpot 53 may have a probability of being won once for every 25,000 wagers.

The probabilities may remain the same even after the progressive jackpots have switched award values. Therefore, after the progressive jackpots have been switched, a progressive jackpot with a relatively high probability of being won may also have the highest award value and a progressive jackpot with a relatively low probability of being won may also have the lowest award value. Players playing gaming apparatus 10 will sense that they have an improved or better chance of winning a larger progressive jackpot at certain times while playing gaming apparatus 10. Players playing gaming apparatus 10 will feel a sense of excitement and anticipation as they view timer display 66 knowing that soon they will be playing for a larger progressive jackpot that is awarded more frequently.

Referring to FIG. 2, controller 76 is also adapted to detect when a progressive jackpot awarding or qualifying event occurs in gaming device 20. This may be accomplished by controller 82 transmitting a signal to controller 76 that a progressive jackpot qualifying event has occurred. For example, controller 82 may determine the outcome of each game and when a progressive jackpot qualifying event outcome occurs, it transmits a signal to controller 76. Alternatively, controller 76 may periodically interrogate controller 82. In another embodiment, one or more sensors may be provided for determining if a progressive jackpot qualifying event has occurred. For example, sensors 84-86 may sense the positions of reels 22-24. When reels 22-24 are in a progressive jackpot qualifying event activating position, controller 76 would sense this position and begin a progressive game sequence (described below).

Referring to FIG. 3, controllers 76A-D Or 82A-D can each inform server 160 that a progressive jackpot qualifying event has occurred in gaming apparatuses 10A-D. Alternatively, server 160 may determine when a jackpot qualifying event occurs and transmit a signal to one of controllers 76A-D.

When controller 76 detects a progressive jackpot qualifying event or is informed of a progressive jackpot qualifying event, it may begin a progressive jackpot sequence by activating display 110. Display 110 may comprise many different kinds of display devices, such as video screens, lights, light emitting diodes, etc. Display 110 may comprise its own controller that is adapted to generate a variety of displays.

Display 110 may indicate that a player has qualified for a progressive jackpot and prompt the player to perform an action. In an embodiment, the player is prompted to start the award sequence by pressing input device 38. Input device 38 may be a simple button, a keyboard, or a touch screen display.

Referring to FIG. 2, when controller 76 detects input device 38 being activated, controller 76 may indicate progressive jackpot 52 as being won by the game player in an embodiment where only one progressive jackpot is awarded. Display 50 may flash or otherwise highlight that progressive jackpot 52 has been won. An indicator such as an arrow may be illuminated or flashed above progressive jackpot 52 in order for a game player to clearly see what they have won. At the same time, the award value for progressive jackpots 53 may be removed from display 50 in order to eliminate any confusion as to which progressive jackpots have been won.

With continued reference to FIGS. 1-4, in an embodiment where either progressive jackpot 52, 53 or both can be awarded, controller 76 performs a routine to determine which of the progressive jackpots will be awarded. In an embodiment, the progressive jackpots to be awarded are randomly selected. Random number generator 77 generates a random number and supplies the random number to controller 76. Controller 76 compares the random number to a pay table similar to that described for gaming device 20 or as described in U.S. Pat. No. 5,823,874, issued to Adams. A simple pay table may appear as follows:

Table 1

| Random Number | Award |
|---|---|
| 0.00 to 0.4 | Jackpot 1 |
| 0.41 to 0.95 | Jackpot 2 |
| 0.96 to 1.00 | Jackpot 1 and Jackpot 2 |

For examples if the random number generator produced 0.98, progressive jackpots 1 (52) and 2 (53) would be indicated as being won and the award values 60 and 61 contained by progressive jackpots 1 (52) and 2 (53) would be added and awarded to the player. If the random number generator produced 0.32, progressive jackpot 1 (52) would be indicated as being won and the award value 60 contained by progressive jackpot 1 would be awarded to the player. This embodiment is not necessarily limited to the example pay table shown. A larger or fewer number of progressive jackpots may be used. Furthermore, different kinds of prizes may be awarded along with a progressive jackpot. For example, a progressive jackpot and a vacation could be awarded or a progressive jackpot and an award to play additional games could be awarded.

Once controller 76 randomly determines which progressive jackpots are to be awarded, controller 76 causes display 50 to indicate the progressive jackpot or jackpots that have been won.

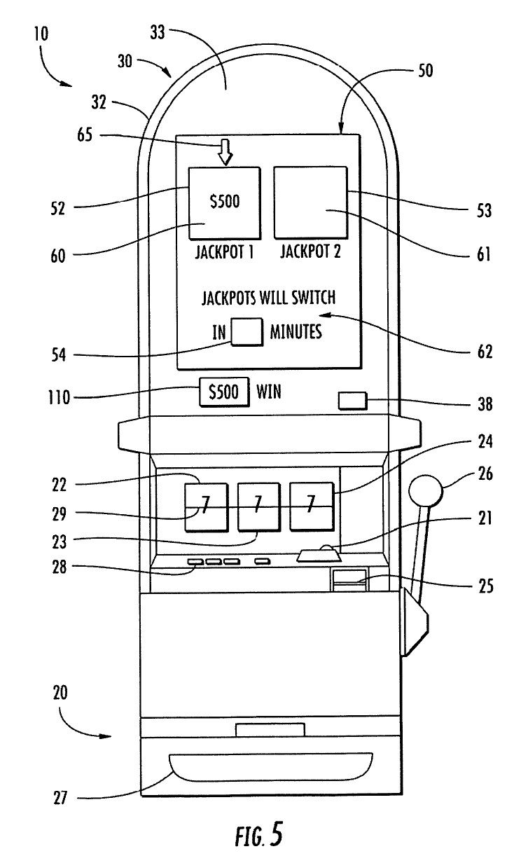

With reference now to FIG. 5, display 50 is shown indicating that the game player has won progressive jackpot 2. An indicator 65 such as an arrow may be illuminated or flashed above progressive jackpot 52 in order for a game player to clearly see what they have won. At the same time, award value 61 for progressive jackpot 53 may be removed from display 50 in order to eliminate any confusion as to which progressive jackpots have been won. If more than one progressive jackpot is to be awarded, an indicator 65 can be illuminated or flashed adjacent to each progressive jackpot that is to be awarded.

Controller 76 may then cause display 110 to display the total prize, if any, that the player has won. The amount of each progressive jackpot may be added by controller 76 and then shown on display 110. Other effects may also be presented, such as pre-recorded sound from speakers. If the actual prize is money, the amount of the prize may be added to the player's credit meter or dispensed.

After controller 76 randomly determines which progressive jackpots are to be awarded, controller 76 informs server 160 of the progressive jackpots awards. Server 160 then updates displays 50A-D on each of gaming devices 10A-D with at least one new progressive award value. For example, progressive jackpot 52 on displays 50A-D maybe set to zero and would then start accumulating value as the progressive jackpot is funded through game play on primary gaming devices 20A-D.

It is also possible to replace the primary display of a gaming device with bonus gaming device 30. In other words bonus gaming device 30 can also be used as a primary or base game apparatus.

Gaming apparatus 10 may also be used with multi-level progressive jackpots. In a multi-level progressive jackpot game, several progressive jackpots are provided that are in a particular order and game players must win each jackpot in sequence before they are eligible to will the next progressive jackpot. When gaming apparatus 10 is used with a multi-level progressive jackpot game, the value of a progressive prize may change even after the progressive jackpot has been won by the game player. For example, if gaming apparatus 10 has two multi-level progressive jackpots, a first progressive jackpot with a value of $100 and a second progressive jackpot with a value of $200. When a game player wins the first progressive jackpot, the player would vin $100 and $100 would be shown on the player's credit meter. At this point, if a jackpot switching event occurs in gaming apparatus 10, the value of the first and second progressive jackpots would switch award values. The player would now have won a $200 progressive jackpot and $200 would now be displayed on the game player's credit meter. The player may stop play and cashout at this point in the game and be awarded $200. If the player continues to play gaming apparatus 10, they would be playing for the possibility of winning the second progressive jackpot that has a new award value of $100.

In one embodiment, once the player has won a particular progressive jackpot, the amount won by the player cannot be reduced regardless of a jackpot switching event occurring. In another embodiment, when a jackpot switching event occurs, a player that has qualified to be awarded a progressive jackpot can play for any of the progressive jackpots that are available to be awarded.

Progressive Jackpot Game Using Three or More Progressive Jackpots

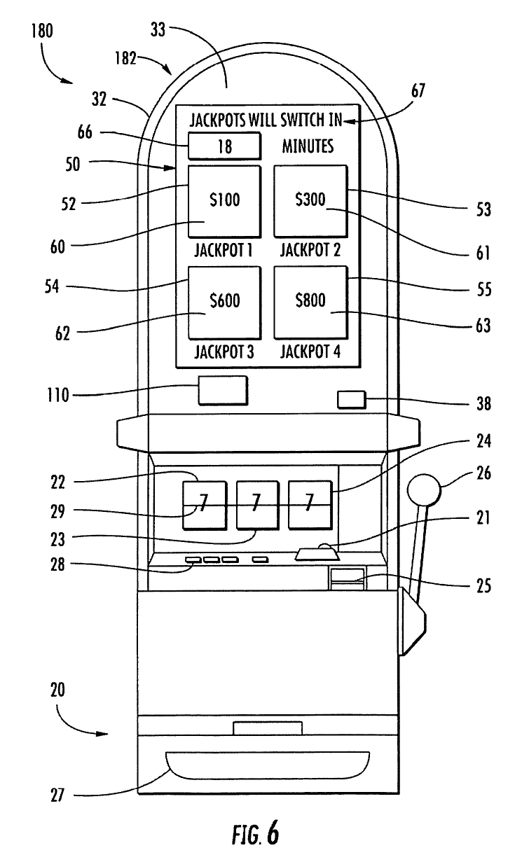

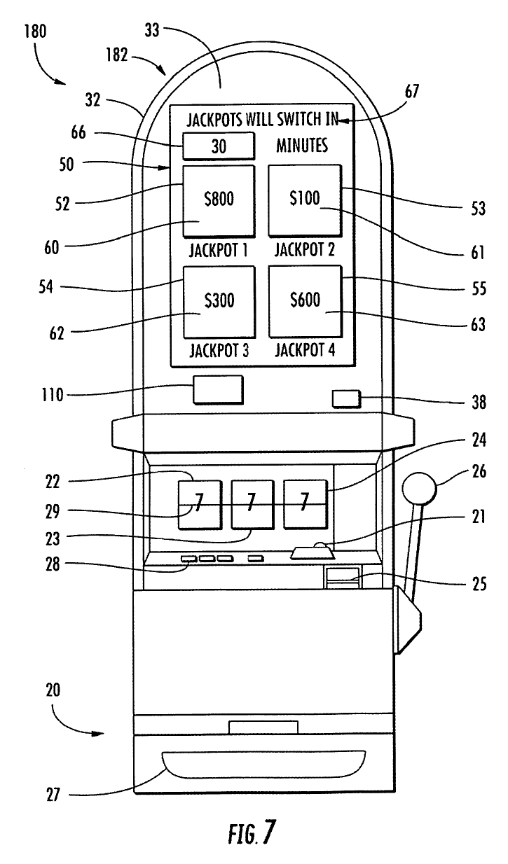

With reference now to FIGS. 6 and 7, another embodiment of a gaming apparatus 180 in accordance with the present invention is shown. Gaming apparatus 180 is similar to gaming apparatus 10 except that instead of two progressive jackpots, gaming apparatus 180 has four progressive jackpots. Gaming apparatus 180 has a primary or base gaming device 20 and a progressive jackpot gaming device 182. Progressive jackpot gaming device 182 has a display 50 that is shown displaying four progressive jackpots. Progressive jackpots 52, 53, 54 and 55 are shown in separate areas of display 50. Alternatively, progressive jackpots 52-55 could be shown on separate LED meters. Gaming apparatuses 180 may be connected in network of gaming apparatuses 150 (FIG. 3) in the same manner previously described for gaming apparatuses 10A-D.

Progressive jackpot 52 is labeled, “Jackpot 1”, progressive jackpot 53 is labeled, “Jackpot 2”, progressive jackpot 54 is labeled, “Jackpot 3” and progressive jackpot 55 is labeled, “Jackpot 4”. Progressive Jackpot 52-55 each has an associated indicia or progressive jackpot award value that can be awarded to a player as a prize. Progressive jackpot 52 has an award value 60 shown as, “$100”. Progressive jackpot 53 has an award value 61 shown as, “$300”. Progressive jackpot 54 has an award value 62 shown as, “$600”. Progressive jackpot 55 has an award value 63 shown as, “$800”.

A game player playing gaming apparatus 180 may be awarded one, two, three or all of progressive jackpots 52-55. In an embodiment, one or more of award values 60-63 may be a hidden or mystery progressive jackpots wherein the award value of the progressive jackpot is not revealed to the game player until after the progressive jackpot has been won.

Progressive Jackpots 52-55 can be funded in a conventional manner wherein a percentage or portion of the wagers placed on each gaming device 10 is reserved to increase the amount of the progressive jackpots.

Display 50 also has a timer or timer display 66 and information set 67. Information set 67 may inform a player about an operating parameter or condition of progressive jackpot gaming device 30. In FIG. 6, information set 67 reads, “Jackpots Will Switch in ______ Minutes”. Timer display 66 can time and display the number of minutes remaining until progressive jackpots 52-55 switch their respective progressive jackpot award values 60-63. For example, in FIG. 6, timer display 66 is showing that 18 minutes remain until the progressive jackpots switch. Timer display 66 can communicate to players when the progressive jackpots will switch and build player anticipation and excitement.

Progressive jackpots 52-55 may switch their respective progressive jackpot award values 60-63 upon the occurrence of a jackpot triggering or switching event as determined by controller 76 (FIG. 2) or server 160 (FIG. 3). Timer or timer display 66 may be a separate unit that may be in communication with progressive game controller 76 (FIG. 2). Alternatively, controller 76 may direct display 50 to show timer 66.

After server 160 or controller 76 has determined that a jackpot triggering or switching event has occurred, controller 76 can change or switch the progressive jackpot award values 60-63. Turning now to FIG. 6 and FIG. 7, The progressive jackpot award value 60 having the value of “$100” of progressive jackpot 1 (52) has been changed or replaced with the progressive jackpot award value 63 having the value of “$800” of progressive jackpot 4 (55). The progressive jackpot award value 61 having the value of “$300” of progressive jackpot 2 (53) has been replaced with the progressive jackpot award value 62 having the value of “$600” of progressive jackpot 3 (54). The progressive jackpot award value 62 having the value of “$600” of progressive jackpot 3 (54) has been replaced with the progressive jackpot award value 61 having the value of “S300” of progressive jackpot 2 (53). The progressive jackpot award value 63 having the value of “$800” of progressive jackpot 4 (55) has been replaced with the progressive jackpot award value 62 having the value of “$600” of progressive jackpot 3 (54).

In the embodiment shown in FIGS. 6 and 7, the progressive jackpot award values are rotated in order between the progressive jackpots such that progressive jackpot 52 takes the award value of progressive jackpot 55, progressive jackpot 53 takes the award value of progressive jackpot 52, progressive jackpot 54 takes the award value of progressive jackpot 53 and progressive jackpot 55 takes the award value of progressive jackpot 54.

In another embodiment, the progressive jackpot having the highest award value is changed to the progressive jackpot having the lowest award value and the progressive jackpot having the lowest award value is changed to the progressive jackpot having the highest award value.

In an additional embodiment, the award values 60-63 of the progressive jackpots may be randomly assigned to any of progressive jackpots 52-55 using a random number generator.

After the jackpots have switched award values, game players playing gaming device 180 may now be playing for a larger progressive prize which is exciting to the player.

In FIG. 7, controller 76 (FIG. 3) or server 160 (FIG. 3) has also reset countdown timer 66. Countdown timer 66 shows that the next switching of the progressive jackpots will occur in 30 minutes. The time period shown by countdown timer 66 may be pre-determined and fixed such as every 30 minutes or may be randomly selected by controller 76 and displayed on countdown timer 66.

Gaming apparatus 180 may award one, two, three or all of progressive jackpots 52-55 using the same techniques to determine the jackpots to be awarded as was previously described for gaming apparatus 10.

Game Play Flow Chart

Referring now to FIGS. 1, 2 and 8, a flowchart of a method of game play 200 using gaming apparatuses 10 and network 150 (FIG. 3) is shown. At step 202, a player may initiate came play method 200 by placing a wager on gaming apparatus 10. The wager may be in form of cash or credit from actual domestic or foreign currency, vouchers, coupons, tickets, electronic cards, and other sources or form is of wagers known in tile art. Once the player initiates game play, the primary game random number generator generates a first random number and randomly determines the base game outcome at step 203. Next, the player may play a base or primary gaming device 20 at step 204.

At decision step 210, the controller checks for or detects the occurrence of a jackpot triggering, changing or switching event. In one embodiment, the jackpot switching event may be the expiration of a time period shown on timer 66. If the controller does not detect a jackpot switching event, method 200 proceeds to decision 216.

If the controller detects that a jackpot switching or changing event has occurred at decision step 210, method 200 proceeds to step 212 where the progressive jackpot award values are switched and displayed according to the pre-determined manner of switching the progressive jackpot award values. At step 214, the countdown timer 66 is reset to start a new time period until the progressive jackpot award values are to be switched again and then proceeds to decision 216.

At decision 216, the controller checks for the occurrence of a jackpot qualifying or awarding event. If the controller does not detect a jackpot awarding event, method 200 proceeds to step 220 where the progressive jackpot funding is determined.

If the controller detects a jackpot awarding event at decision step 216, the progressive jackpot game determines the progressive jackpot to be awarded and displays and awards any progressive jackpot prizes at step 218. One or more of the progressive jackpots may be awarded as a prize to the game player.

Next method 200 proceeds to step 220 where funding of the progressive jackpots is determined. Step 220 may include apportioning a percentage of the wagers on primary gaming device 20 and determining how to allocate the collected amounts between the progressive jackpots. After the progressive jackpot funding is determined in step 220, the progressive jackpots are incremented in step 222.

Next, the controller notifies the player of the game outcome from the base game at step 208. Method 200 then returns to step 202 where the player may place another wager and play gaming apparatus 10 again.

Gaming apparatus 180 of FIGS. 6 and 7 may also be played using game method 200.

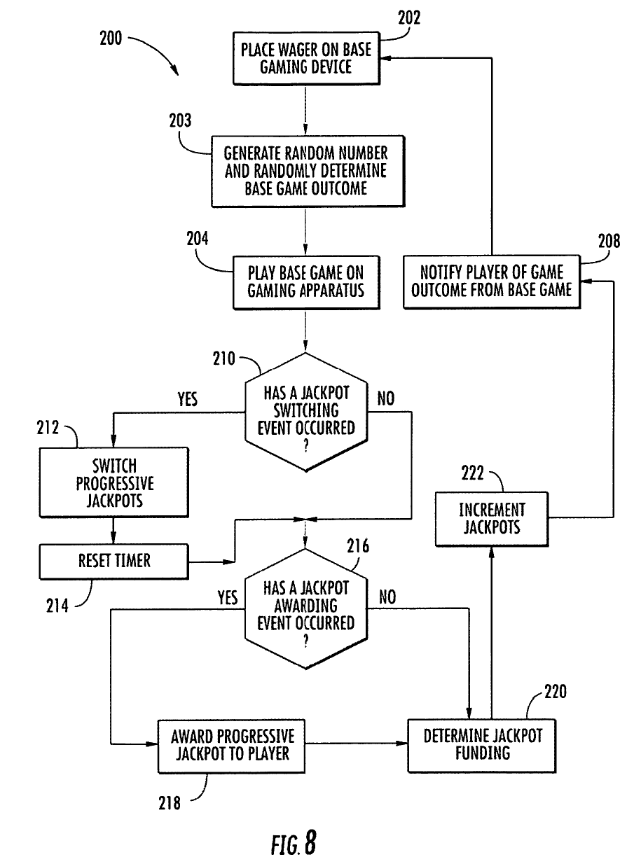

The steps shown in the flowchart of FIG. 8 do not necessarily imply that the steps have to take place in a particular order. The order of steps may be varied; some steps may be eliminated; and, some steps may be replaced with other steps. Such variations still fall within the scope of the invention.

Alternative Game Play Flow Chart

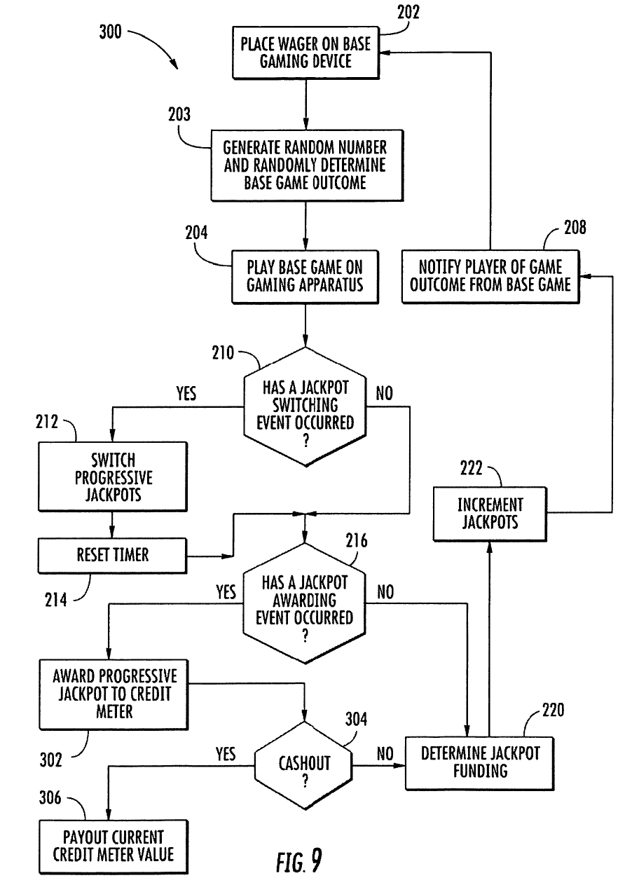

Referring now to FIGS. 1, 2 and 9, a flowchart of another method of game play 300 using gaming apparatuses 10 and network 150 (FIG. 3) is shown. Method 300 is similar to method 200 except that method 300 allows for a progressive jackpot to be changed or switched for another progressive jackpot award value after the progressive jackpot has been awarded.

At step 202, a player may initiate game play method 300 by placing a wager on gaming apparatus 10. The wager may be in form of cash or credit from actual domestic or foreign currency, vouchers, coupons, tickets, electronic cards, and other sources or forms of wagers known in the art. Once the player initiates game play, the primary game random number generator generates a first random number and randomly determines the base game outcome at step 203. Next, the player may play a base or primary gaming device 20 at step 204.

At decision step 210, the controller checks for or detects the occurrence of a jackpot triggering, changing or switching event. In one embodiment, the jackpot switching event may be the expiration of a time period shown on timer 66. If the controller does not detect a jackpot switching event, method 300 proceeds to decision 216.

If the controller detects that a jackpot switching or changing event has occurred at decision step 210, method 300 proceeds to step 212 where the progressive jackpot award values are switched and displayed according to the pre-determined manner of switching the progressive jackpot award values. Step 212 may include switching or changing progressive jackpots that have already been awarded.

At step 214, the countdown timer 66 is reset to start a new time period until the progressive jackpot award values are to be switched again and then proceeds to decision 216.

At decision 216, the controller checks for the occurrence of a jackpot qualifying or awarding event. If the controller does not detect a jackpot awarding event, method 300 proceeds to step 220 where the progressive jackpot funding is determined.

If the controller detects a jackpot awarding event at decision step 216, the progressive jackpot game determines the progressive jackpot to be awarded and displays and adds any progressive jackpot prizes to the game player's credit meter at step 302. One or more of the progressive jackpots may be awarded as a prize to the game player.

At decision 304, method 300 checks to see if the game player has chosen to cashout and collect their accumulated credit balance. If a cashout event is not detected, method 300 proceeds to step 220 where the progressive jackpot funding is determined.

If a cashout event is detected, at step 304, method 300 proceeds to step 306 where the current value of the game player's credit meter including any progressive prizes may be paid to the game player in the form of currently or a voucher.

At step 220 funding of the progressive jackpots is determined. Step 220 may include apportioning a percentage of the wagers on primary gaming device 20 and determining how to allocate the collected amounts between the progressive jackpots. After the progressive jackpot funding is determined in step 220, the progressive jackpots are incremented in step 222.

Next, the controller notifies the player of the game outcome from the base game at step 208. Method 300 then returns to step 202 where the player may place another wager and play gaming apparatus 10 again.

Gaming apparatus 180 of FIGS. 6 and 7 may also be played using game method 300.

The steps shown in the flowchart do not necessarily imply that the steps have to take place in a particular order. The order of steps may be varied; some steps may be eliminated; and, some steps may be replaced with other steps. Such variations still fall within the scope of the invention.

### CONCLUSION

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A gaming apparatus comprising:
(A) at least one gaming device that is adapted to accept a wager and allow a player to play a game; and
(B) a controller in communication with the gaming device, the controller being adapted to maintain a first progressive jackpot having a first award value and a second progressive jackpot having a second award value wherein upon the occurrence of a triggering event, the first and second award values are switched.

2. The gaming apparatus of claim 1, wherein the triggering event is the expiration of a time period.

3. The gaming apparatus of claim 1, wherein the triggering event occurs randomly.

4. The gaming apparatus of claim 1, further comprising a timer in communication with the controller, the timer being adapted to display a period of time until the first and second award values are switched.

5. The gaming apparatus of claim 1, wherein at least one of the progressive jackpots has a hidden award value.

6. The gaming apparatus of claim 1, wherein the controller is adapted to maintain a third progressive jackpot having a third award value, wherein upon the occurrence of the triggering event, the first, second and third award values are switched.

7. The gaming apparatus of claim 1, wherein the first and second progressive jackpots are multi-level progressive jackpots such that the second progressive jackpot is awarded after the first progressive jackpot has been won.

8. A method of gaming, comprising, not all necessarily in the order shown:
(A) allowing a player to place a wager and play a game;
(B) funding a first progressive jackpot having a first value and a second progressive jackpot having a second value;
(C) detecting the occurrence of a jackpot switching event;
(D) replacing the first value of the first progressive jackpot with the second value of the second progressive jackpot; and
(E) replacing the second value of the second progressive jackpot with the first value of the first progressive jackpot.

9. The method of claim 8, further comprising displaying a time period until the first and second award values are replaced.

10. The method of claim 8, wherein at least one of the progressive jackpots is a hidden jackpot.

11. The method of claim 8, wherein the jackpot switching event is the expiration of a time period.

12. The method of claim 8, wherein the jackpot switching event occurs randomly.

13. A gaming apparatus comprising:
(A) gaming means for allowing a player to play a game;
(B) display means for displaying a plurality of progressive jackpots, each of the progressive jackpots having a value, the display means mounted in association with the gaming means; and
(C) controller means for determining a jackpot switching event, the controller means in communication with the gaming means and the display means, the controller means being adapted to switch the values of the progressive jackpots in response to the occurrence of the jackpot switching event.

14. The gaming apparatus of claim 13, wherein the jackpot switching event is the expiration of a time period.

15. The gaming apparatus of claim 13, wherein the jackpot switching event occurs randomly.

16. The gaming apparatus of claim 13, further comprising timer means for displaying a period of time, the timer means being in communication with the controller, the timer being adapted to display a period of time until the values are switched.

17. The gaming apparatus of claim 16, wherein the timer means are mounted with the display means such that the player can view when the values will be switched.

18. The gaming apparatus of claim 13, wherein the progressive jackpots are multi-level progressive jackpots such that a second progressive jackpot is awarded after a first progressive jackpot has been awarded.

19. A method of gaming, comprising, not all necessarily in the order shown:
(A) allowing a player to place a wager and play a game;
(B) displaying, a first progressive jackpot having a first progressive jackpot value and a second progressive jackpot having a second progressive jackpot value;
(C) determining if a jackpot switching event has occurred; and
(D) if the jackpot switching event has occurred, switching the value of the first progressive jackpot with the value of the second progressive jackpot.

20. The method of claim 19, further comprising displaying a time period until the first and second progressive jackpot values are switched.

21. The method of claim 19, further comprising:
(A) determining if a jackpot awarding event has occurred; and
(B) if the jackpot awarding event has occurred, awarding at least one of the progressive jackpots.
